(19) United States
(12) Patent Application Publication
(10) Pub. No.: US 2016/0140822 A1
(43) Pub. Date: May 19, 2016

(54) System and Method of Airflow Monitoring for Variable Airflow Environments

(71) Applicant: Honeywell International Inc., Morristown, NJ (US)

(72) Inventors: Edward J. Kurtz, Saint Charles, IL (US); Scott R. Lang, Geneva, IL (US)

(21) Appl. No.: 14/547,499

(22) Filed: Nov. 19, 2014

(51) Int. Cl. G08B 17/10

(52) U.S. Cl. CPC G08B 17/10

(57) ABSTRACT

A method of operating an aspirated smoke detector includes providing an ambient condition detector, establishing a first flow baseline for the detector, and, establishing a second, lower, flow baseline for the detector. A selected airflow is sampled, and determining if the airflow sample should be compared to the first flow baseline or the second flow baseline, and, responsive thereto determining if a trouble indictor should be generated.

### FIELD

The application pertains to control systems and methods for monitoring variable airflows which might impact operation of ambient condition detectors. More particularly, the application pertains to such systems and methods to improve operationality of aspirating smoke detectors in varying airflow environments.

### BACKGROUND

Aspirating smoke detectors are known and useful in a variety of commercial and industrial environments. When commissioned, aspirating smoke detectors establish an airflow baseline for the air that flows through the devices. During the operating life of the product the current air flow is monitored and compared to the baseline that was established during commissioning. When the current flow measurement deviates from the baseline airflow established during commissioning a trouble conditions is reported to the operator of the equipment.

Aspirating smoke detectors are often used to monitor airflow on the return air grills for HVAC units. During operation HVAC units may continuously cycle on and off which can result in periods of high air flow followed by periods of stagnant air. These changes in airflow can cause an aspirating smoke detector to generate trouble conditions due to the current air flow when compared to the established baseline.

### BRIEF DESCRIPTION OF THE DRAWINGS

FIG. 1 illustrates a block diagram of a system in accordance herewith; and

FIG. 2 is a flow diagram illustrating aspects of a method in accordance herewith.

### DETAILED DESCRIPTION

While disclosed embodiments can take many different forms, specific embodiments thereof are shown in the drawings and will be described herein in detail with the understanding that the present disclosure is to be considered as an exemplification of the principles thereof as well as the best mode of practicing same, and is not intended to limit the application or claims to the specific embodiment illustrated.

In one aspect, embodiments hereof more than one baseline is established. For example a baseline for when the HVAC unit is running at its maximum velocity and a second when the HVAC unit is off, would allow the device to account for the large airflow changes and prevent false trouble conditions.

The aspirating smoke detector could have an input from the HVAC unit which would indicate when the system is running and the unit could determine which airflow baseline should be used for indicating a trouble condition if such a condition exists. Example inputs could be ‘airflow on’, ‘airflow off’, input from an anemometer, etc.

In yet another aspect, when initializing the device will establish two baselines, one when the HVAC unit is on and one when it is off. During normal operation the device will sample the current airflow and compare it to the appropriate baseline value. The device selects the baseline to compare the current reading to by reading the input from the HVAC unit or from an external flow monitoring sensor.

If the flow varies by a percentage indicative of a trouble condition then the device will report an airflow trouble condition.

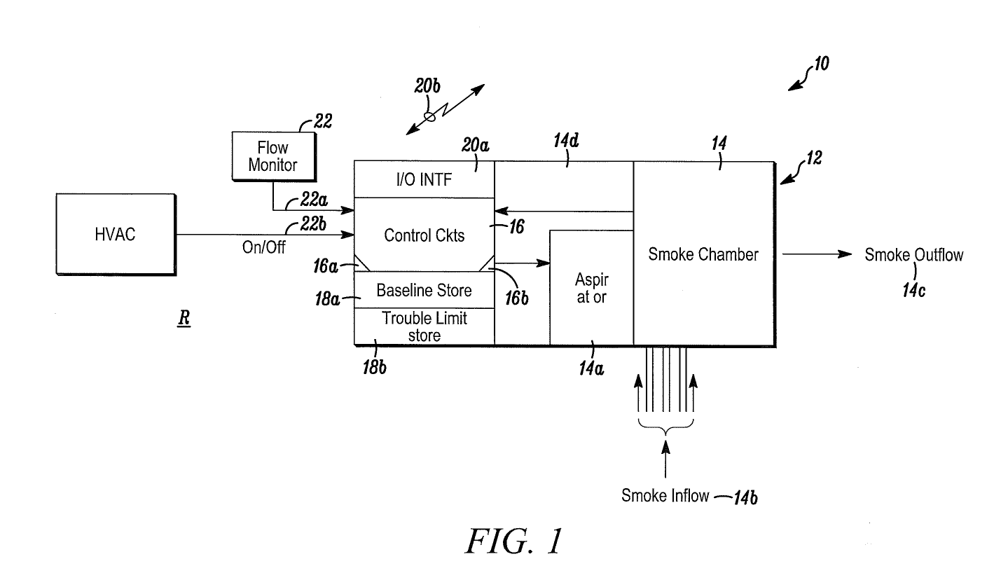

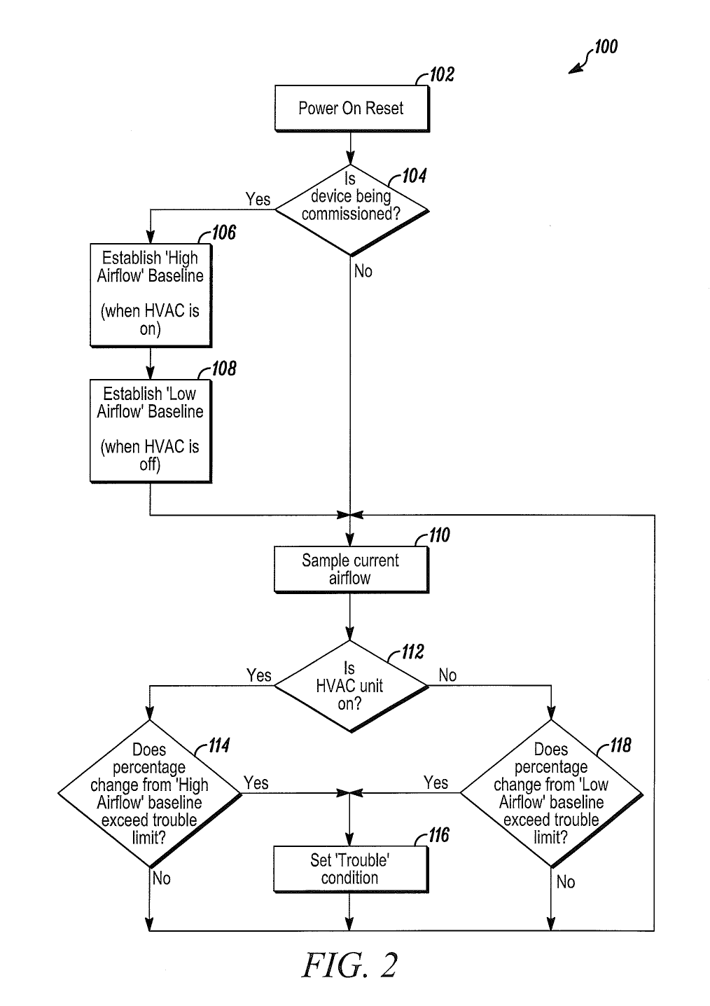

FIGS. 1, 2 illustrate respectively aspects of a system 10 in accordance herewith along with a method 100. System 10 includes an ambient condition detector 12, which could be an aspirating smoke detector. Detector 12 includes a smoke chamber 14, an aspirator 14a, smoke inflow conduits 14b, and smoke outflow conduits 14c.

Detector 12 is coupled to control circuits 16 by an output signal line 14d. As those of skill will understand, the signals on line 14d are indicative of smoke detected in chamber 14.

The control circuits 16 can be implemented at least in part by one or more programmable processors 16a which can execute instructions 16b located at the detector 12.

A storage element 18a is coupled to circuits 16, and provides storage for at least two different baseline values. Storage element 18b is also coupled to circuits 16 and provides storage for at least one trouble limit value. The usefulness of these stored values is discussed subsequently.

A flow monitor 22 can provide output signals, on a line 22a indicative of sensed flow in a target area or region such as region R. Line 22b can couple an on/off signal for the HVAC unit indicative of when it is energized and operating to provide heat, ventilation or cooling to the region R.

System 10 can operate in a variety of modes. One operational mode is illustrated in FIG. 2 as method 100. Initially detector 12 can be energized and reset as at 102. A determination is made as to whether detector 12 is being put into service, or commissioned, as at 104. If so, high air flow and low airflow baselines, indicative operating state of HVAC unit, can be established as at 106, 108. Such values can be stored as discussed above in baseline store 18a. Optionally, a trouble limit value can be stored in unit 18b at this time.

Subsequently, when detector 12 is placed to service a region such as region R, a current airflow is sampled, as at 110, via a flow monitor such as 22. A determination is made, as at 112, as to the state of the HVAC unit. An electrical signal 22b indicative of this state can be coupled to control circuits 16. This signal provides information as to whether the HVAC unit is energized, and on, or, not energized, and off.

If the determination is that the HVAC unit is on, another determination is made, as at 114, as to whether a percentage change, the trouble limit value, from the high airflow baseline exceeds the trouble limit. If so, a trouble condition is indicated, as at 116. An indicium of this state can then be transmitted via interface 20a and medium 20b to a displaced monitoring or security location.

If the HVAC unit is not on, as at 112, a determination is made, as at 118, as to whether the percent change, the same or a different trouble limit value, from the low airflow base line exceeds that trouble limit. If so the trouble condition is indicated, as at 116.

Those of skill will understand that neither the specific details of the exemplary system 10, nor details of method 100 are limitations hereof excepted as described herein. If desired multiple pairs of baseline, and multiple trouble limit values can be stored in units 18a, b without departing from the spirit and scope hereof.

From the foregoing, it will be observed that numerous variations and modifications may be effected without departing from the spirit and scope hereof. It is to be understood that no limitation with respect to the specific apparatus illustrated herein is intended or should be inferred. It is, of course, intended to cover by the appended claims all such modifications as fall within the scope of the claims. Further, logic flows depicted in the figures do not require the particular order shown, or sequential order, to achieve desirable results. Other steps may be provided, or steps may be eliminated, from the described flows, and other components may be add to, or removed from the described embodiments.

1. An apparatus comprising:
an ambient condition detector
at least first and second predetermined flow thresholds;
a flow indicting signal;
control circuits in the detector, coupled to the flow indicating signal wherein the control circuits compare the signal to at least one flow threshold and responsive thereto determines if a trouble indicator should be generated.

2. An apparatus as in claim 1 where at least one of the first and second thresholds is stored in an electronic storage element and coupled to the control circuits.

3. An apparatus as in claim 1 where the flow indicting signal comprises one of a binary signal, and an analog signal.

4. An apparatus as in claim 3 wherein the signal values are indicative of one of a first flow rate or a second, lower flow rate.

5. An apparatus as in claim 1 where the detector comprises an aspirated smoke detector.

6. An apparatus as in claim 5 where at least one of the first and second thresholds is stored in an electronic storage element and coupled to the control circuits.

7. An aspirated smoke detector comprising:
control circuits coupled to a smoke indicating signal, first and second baseline indicating values and an indicator that couples realtime flow values to the control circuits, wherein the control circuits establish at least one parameter to determine if a trouble condition is present.

8. An aspirated smoke detector as in claim 7 wherein the at least one parameter comprises a value indicative of an acceptable variation between a sensed, real time flow value and at least one predetermined threshold.

9. An aspirated smoke detector as in claim 8 wherein the control circuits compare the flow indicting signal to both of the baselines and responsive thereto, make a determination as to the presence of the trouble condition.

10. A method comprising:
providing an ambient condition detector;
establishing a first flow baseline for the detector;
establishing a second, lower, flow baseline for the detector;
sampling a selected airflow; and
determining if the airflow sample should be compared to the first flow baseline or the second flow baseline, and, responsive thereto determining if a trouble indictor should be generated.

11. A method as in claim 10 including establishing a trouble limit value and using that value in determining if the trouble indictor should be generated.

12. A method as in claim 11 where determining if the if the trouble indicator should be generated includes determining if a variation between a selected baseline and the sample airflow value exceeds the trouble limit value.

13. A method as in claim 12 where providing includes providing an aspirated detector.

14. A method as in claim 13 which includes storing the trouble limit value in the detector.

15. A method as in claim 14 which includes storing the baselines in the detector.

16. A method as in claim 15 includes exposing the detector to the selected air low prior to sampling the airflow.

17. A method as in claim 16 which includes determining if a flow generating unit is in a first, active, state or a second, inactive, state after sampling the selected airflow.

18. A method as in claim 16 where, responsive to detecting the state of the unit, a sampled airflow value is compared to a selected baseline value.

19. A method as in claim 18 which includes providing a time based sequence of sampled air flow values.

20. A method as in claim 10 which includes associating a first sensitivity with the first flow baseline, and a second, different, sensitivity with the second flow baseline.
